(19) United States
(12) Patent Application Publication
(10) Pub. No.: US 2019/0290044 A1
(43) Pub. Date: Sep. 26, 2019

(54) Christmas tree watering device

(71) Applicant: Tracy Hurst, Harding, PA (US)

(72) Inventor: Tracy Hurst, Harding, PA (US)

(21) Appl. No.: 16/278,496

(22) Filed: Feb. 18, 2019

Related U.S. Application Data
(60) Provisional application No. 62/647,782, filed on Mar. 25, 2018.

(51) Int. Cl. A47G 33/08; G08B 21/18

(52) U.S. Cl. CPC A47G 33/0881; A47G 2033/0827; G08B 21/182; A47G 33/0818

(57) ABSTRACT

Disclosed is a Christmas tree watering device. The watering device may include a removable façade, similar to a Christmas tree ornament, and a tube which extends down the trunk of the tree into the reservoir of the stand. The façade may be easily removable. The façade may conceal a slender, funnel-shaped filling aperture. Optionally, the façade may be provided in the form of a Santa Claus face, with a large, round mouth leading into the aperture. The watering device may include a sensor, a speaker, and one or more LED lights to alert a user that the tree needs watering, and may also provide an audible alert while pouring, indicating that the reservoir is full, to prevent overfilling.

### RELATED APPLICATION(S)

Under provisions of 35 U.S.C. § 119e, the Applicant(s) claim the benefit of U.S. provisional application No. 62/647,782 filed Mar. 25, 2018, which is incorporated herein by reference.

### FIELD OF THE INVENTION

The present invention relates generally to holiday decorations and related devices, and in particular to a Christmas tree watering device.

### BACKGROUND OF THE INVENTION

For millions of people in North America, the availability of artificial versions has not dampened their preference for displaying a freshly cut Christmas tree. This is particularly true for more traditional households. Unfortunately, once the tree has been cut, it is dead and the needles will quickly dry out and begin falling off the branches. Keeping the tree mounted in a stand which provides a reservoir of water will substantially slow down this process, since the water will still be drawn upward into the trunk and be distributed to the needles. Keeping the tree watered throughout the holiday season can become a tiresome chore, particularly for elderly or disabled users, since the branches extend close to the floor, and the user must perform the task on hands and knees.

A search of the prior art reveals various devices which have been developed to address this set of problems, or related problems. None are closely related to the present invention, but several include features which resemble those of the present invention. Each has proven to be less than satisfactory for the present purpose in its own way.

The U.S. Pat. No. 5,921,025 (priority Jan. 20, 1998), titled “Self-watering plant pot” discloses a self-watering plant pot consisting of an outer pot, a liner of translucent or semi-translucent material that fits within the outer pot, a soil platform assembly that divides the liner into a soil compartment and a water reservoir, an optional float positioned in the water reservoir, and a water delivery channel for allowing water and air to be introduced into the water reservoir. The water delivery channel can be a water delivery tube extending upward from the soil platform. The outer pot is typically opaque and includes a side window opening near its base. The water level in the water reservoir and, if a float is employed, the position of the float are visible through the liner and window opening in the outer pot. Water is conveyed from the water reservoir to the soil via capillary action.

The U.S. Pat. No. 3,576,088 (priority Dec. 20, 1968), titled “Plant receptacle with water supply” discloses a self-watering plant receptacle containing water in its bottom portion, over which is disposed a perforated soil support covered with a material which extends over a side of the soil support into the water to form a wick. A filling tube extends down from the upper edge of the container through the soil support, the filling tube containing filaments extending therethrough connected to the bottom of the wick to draw it from the water and control water intake thereby.

The U.S. Pat. No. 6,108,970 (priority Mar. 13, 1997), titled “Self-watering plant guard” discloses a plant guard that may be used to deliver water to a plant adjacent to which the guard is positioned. The plant guard comprises an elongate tubular body which is adapted to contain water, and the interior of the body is divided by vertical seams into upper and lower reservoir compartments and a plurality of vertical reservoirs interconnecting the upper and lower reservoirs. An aperture adjacent the upper edge permits the addition of water, and a water release outlet adjacent the lower edge permits delivery of the water to the plant in a controlled manner.

The U.S. Patent Appl. No. 2002/0189163 (priority Jun. 8, 2001), titled “Self-watering plant holder” discloses a self-watering plant holder having a central, upright post with four horizontal radial arms extending outwardly thereof. A plant container, such as a bucket with a handle, is mounted on each radial arm. A base extends radially outwardly in a preferred embodiment from the lower end of the post to support the post. A manifold is mounted to the post, and houses a chamber with a closure for the addition of water and/or fertilizer. Watering lines extend from the manifold into one or more of the plant containers for watering and/or feeding the plants.

The U.S. Pat. No. 3,069,807 (priority Mar. 30, 1959) titled “Device for watering and feeding plants, flowers and the like” discloses a device for watering and feeding plants by a capillary or combined capillary and siphon system. It permits one to observe more carefully the amount of Water and liquid plant food consumed, and to more carefully measure it. It also permits extended watering of plants during vacations or absences. It permits the feeding and the watering of plants in such a way as to encourage deeper rooting, and where, as in the case of certain plants, better results are obtained by avoiding surface watering. It reduces stem scalding and other damage which is often caused by repeated surface watering, and at the same time feeds and waters to the demands of the plant, slowing when the demand is light and speeding up when the demand increases.

Accordingly, there is a need for an improved watering device for plants that may also overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some embodiments, a Christmas tree watering device is disclosed. The watering device may include a removable façade, similar to a Christmas tree ornament, and a tube which extends down the trunk of the tree into the reservoir of the stand. The façade may be easily removable. The façade may conceal a slender, funnel-shaped filling aperture. Optionally, the façade may be provided in the form of a Santa Claus face, with a large, round mouth leading into the aperture. The watering device may include a sensor, a speaker, and one or more LED lights to alert a user that the tree needs watering, and may also provide an audible alert while pouring, indicating that the reservoir is full, to prevent overfilling.

Further, the disclosed Christmas tree watering device may be used to quickly and easily refill the reservoir from a standing position.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a rear perspective view of a watering device, in accordance with a first exemplary embodiment

FIG. 2 is a front view of the watering device of FIG. 1.

FIG. 3 is a side view of the watering device of FIG. 1.

FIG. 4 is a front perspective close-up view of a façade of the watering device of FIG. 1.

FIG. 5 is a side perspective view of the watering device of FIG. 1 mounted on a Christmas tree.

FIG. 6 is a side perspective view of the watering device of FIG. 1 mounted on the Christmas tree.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of watering devices for elevator tracks, embodiments of the present disclosure are not limited to use only in this context.

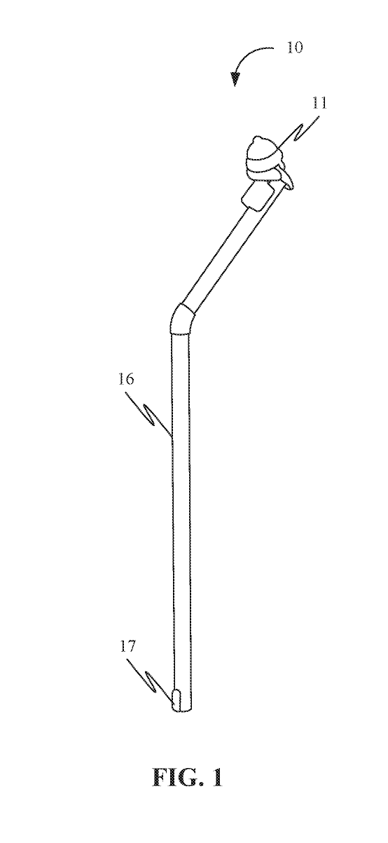

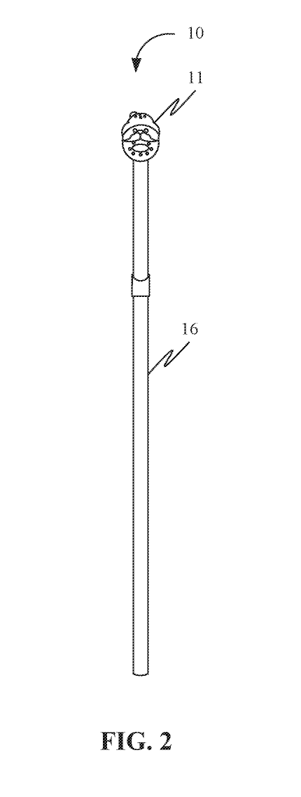

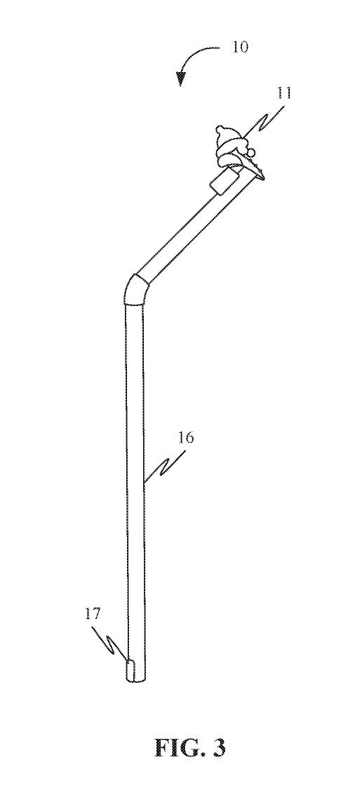

FIG. 1 is a rear perspective view of a watering device 10, in accordance with a first exemplary embodiment. The watering device 10 may include a façade 11, a tube 16, and a sensor 17. FIG. 2 is a front view of the watering device 10. FIG. 3 is a side view of the watering device 10.

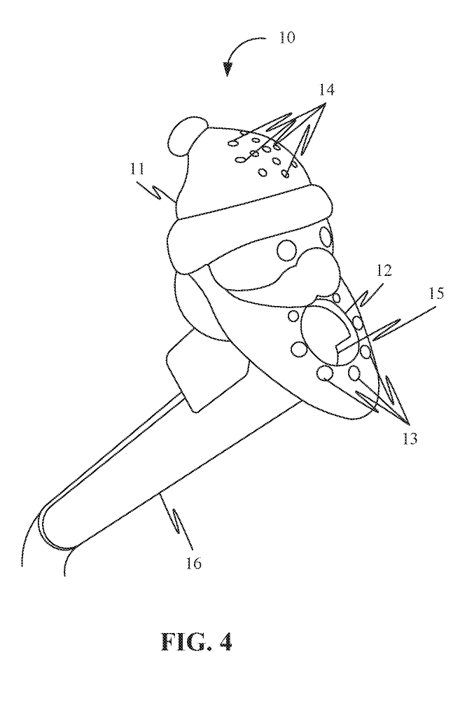

FIG. 4 is a front perspective close-up view of a façade 11 of the watering device 10. The façade 11 may include one or more of a mouth 12, light emitting diode (LED) lights 13, a speaker 14, an aperture 15, and a tube 16.

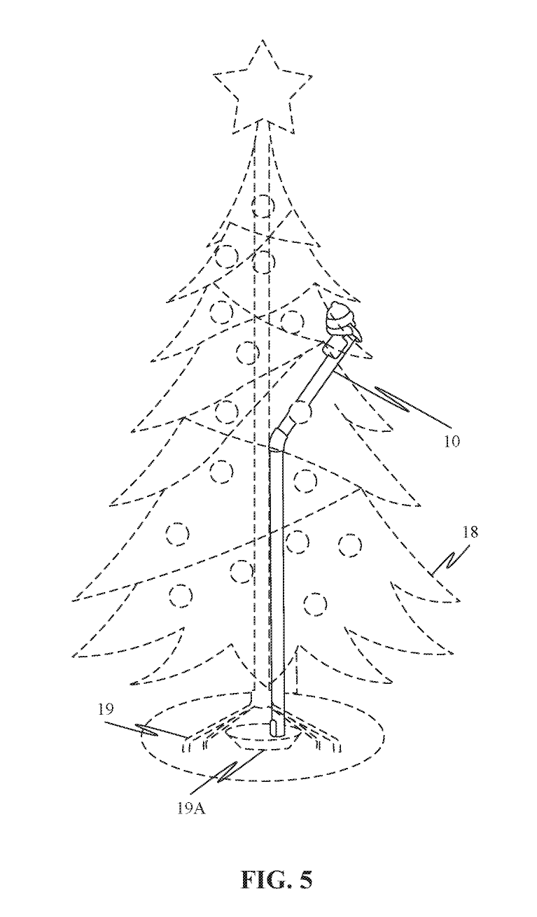

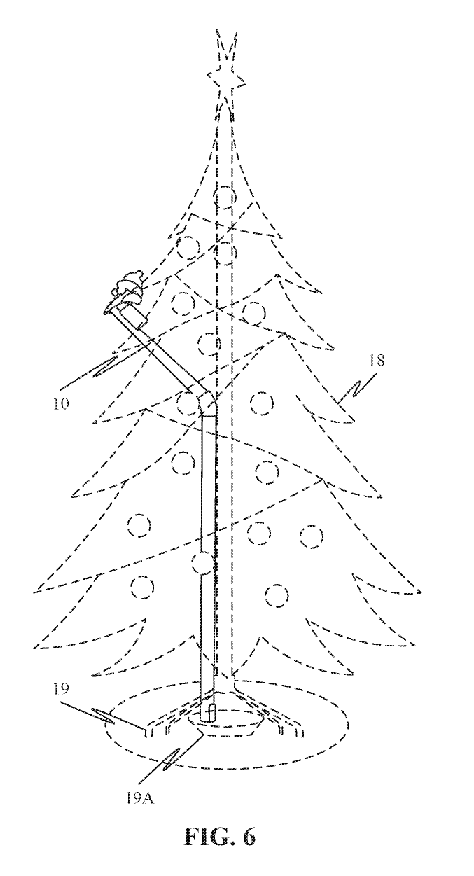

FIG. 5 is a side perspective view of the watering device 10 mounted on a Christmas tree 18. FIG. 6 is a side perspective view of the watering device 10 mounted on the Christmas tree 18. Further, the Christmas tree 18 may include a stand 19, and a water reservoir 19A.

Further, the watering device 10 may include the removable façade 11 in the form of a Santa Claus face, providing a large, round, open mouth 12. Further, a ring of the LED lights 13 may surround the mouth 12. The forehead area of the façade 11 may include the speaker 14.

Further, the façade 11 may include a compartment (not shown) that may contain a microprocessor, a memory device, and a removable, rechargeable battery pack. The compartment may be located directly behind the speaker 14. The battery pack may be plugged into any standard wall outlet for recharging. Accordingly, a removable power cord and an adapter may be provided for recharging the battery pack. Further, two battery packs may be provided, such that one battery pack may be recharged while the other is in use. In alternate embodiments, disposable batteries, without a power cord or adapter, may be used. Further, the LED lights 13 and the speaker 14 of the façade 11 may be connected to the battery pack via a plug connector, which may be pulled out of its socket when the façade 11 is removed. The side surface of the façade 11 may include an on/off switch (not shown).

Further, the watering device 10 may include a tube 16, extending upward vertically for a length (say, 3 feet), then bending at an angle (say, 45° angle) and extending upward diagonally for a length (say, 18 inches). Longer and shorter lengths of tube 16 are also contemplated. The upper end of the tube 16 may terminate in a tapering, funnel-shaped aperture 15 which may be removably attached to the rear of the mouth 12 of the façade 11, such that a user may pour water through the mouth 12 and directly into the aperture 15.

Further, a lower end of the tube 16 may terminate in a sensor 17, which may detect when a water level rises to a predetermined high level (such as 1.25 inches), and when a water level declines to a predetermined low level (such as 0.25 inches), sending an electric signal via a wire to the microprocessor upon occurrence of either of these events. The sensor 17 also draws power from the battery pack via the same wire.

In some embodiments, the tube 16 may be manufactured from green polymerized vinyl chloride (PVC), and may provide a plurality of clamps such that it may be easily attached to the trunk of a Christmas tree 18, such that the sensor 17 is resting in the water reservoir 19A of the Christmas tree stand 19.

In alternate embodiments, the removable façade 11 may be provided in the form of some other Christmas related image, such as a poinsettia or a Christmas star. In such embodiments, since a mouth 12 is not provided, the façade 11 may be removed to pour water into the aperture 15.

To use the watering device 10, a user may affix the tube 16 to the trunk of a Christmas tree 18 such that the sensor 17 is resting in the water reservoir 19A of the stand 19. Then, the user may activate the on/off switch in the façade 11 that may cause the LED lights 13 to illuminate, and also activate the sensor 17. Optionally, the speaker 14 may be used to play Christmas music or some other audio file stored on the memory device.

Further, if the water level in the water reservoir 19A drops below the predetermined low level, the corresponding signal from the sensor 17 may cause the microprocessor to play a distinct audio signal, such as a deep male voice saying “Ho ho ho,” at predetermined time intervals (such as 30 seconds). At the same time, the LED lights 13 may begin flashing. The user may then pour water through the mouth 12 of the façade 11, into the aperture 15, such that the water travels down the tube 16 and into the water reservoir 19A. When the water reaches the predetermined high level, the corresponding signal from the sensor 17 may cause the microprocessor to play a different audio signal, such as the same male voice saying “All done,” followed by a return to any regularly played audio files such as Christmas music. This may prevent water spills due to overfilling.

In some embodiments, the façade 11 and the LED lights 13 may be manufactured from a rigid, durable material, such as plastic. The speaker 14, the sensor 17, the microprocessor, the memory device, the battery pack, and the adapter may be manufactured from rigid, durable materials such as steel, brass, plastic, ceramics, copper alloy, and aluminum alloy. Components and methods listed above are preferable, but artisans will recognize that alternate components and methods could be selected without altering the scope of the invention.

Although the invention has been explained in relation to its preferred embodiment, it is to be understood that many other possible modifications and variations can be made without departing from the spirit and scope of the invention.

What is claimed is:

1. A Christmas tree watering device which provides a removable façade in the form of a Santa Claus face, providing LED lights around a large, round, open mouth, covering a compartment which provides a microprocessor, a memory device, and a removable, rechargeable battery pack, and further providing a tube, extending upward vertically for a length of 3 feet, then bending at a 45° angle and extending upward diagonally for another 18 inches, such that a user may pour water through the mouth and directly into the aperture.

2. The watering device of claim 1, wherein the compartment is located directly behind a speaker.

3. The watering device of claim 1, wherein the battery pack may be plugged into any standard wall outlet for recharging.

4. The watering device of claim 1, wherein the LED lights and the speaker of the façade are connected to the battery pack via a plug connector, which is pulled out of its socket when the façade is removed.

5. The watering device of claim 1, wherein the side surface of the façade provides an on/off switch.

6. The watering device of claim 1, wherein the upper end of the tube terminates in a tapering, funnel-shaped aperture which is removably attached to the rear of the mouth of the façade, such that a user may pour water through the mouth and directly into the aperture.

7. The watering device of claim 1, wherein the lower end of the tube terminates in a sensor, which detects when a water level rises to a predetermined high level such as 1.25 inches, and when a water level declines to a predetermined low level such as 0.25 inch, sending an electric signal via a wire to the microprocessor upon occurrence of either of these events.

8. The watering device of claim 1, wherein the tube 16 is manufactured from green polymerized vinyl chloride (PVC), and provides a plurality of clamps such that it may be easily attached to the trunk of a Christmas tree, such that the sensor is resting in the water reservoir of the Christmas tree stand.

9. The watering device of claim 1, wherein the user may affix the tube to the trunk of a Christmas tree such that the sensor is resting in the water reservoir of the stand.

10. The watering device of claim 1, wherein if the water level in the reservoir drops below the predetermined low level, the corresponding signal from the sensor causes the LED lights to begin flashing, and causes the microprocessor to play a distinct audio signal at predetermined time intervals, such as 30 seconds.

11. The watering device of claim 1, wherein when the user pours water into the mouth and the water reaches the predetermined high level, the corresponding signal from the sensor causes the microprocessor to play a different audio signal, followed by a return to any regularly played audio files such as Christmas music.
